(19) United States
(12) Patent Application Publication
(10) Pub. No.: US 2009/0266475 A1
(43) Pub. Date: Oct. 29, 2009

(54) ADHESIVE TAPE FOR ROLL CHANGE OF FLAT-WEB MATERIALS

(75) Inventors: Stefan Wulf, Monchengladbach (DE); Gerhard Bir, Hamburg (DE); Christoph Nagel, Hamburg (DE); Imke Schwarz, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: tesa SE, Hamburg (DE)

(21) Appl. No.: 12/429,206

(22) Filed: Apr. 24, 2009

(30) Foreign Application Priority Data
Apr. 28, 2008 (DE) 10 2008 021 247.4

(51) Int. Cl. B65H 19/00; B32B 33/00

(52) U.S. Cl. 156/157; 428/42.2

(57) ABSTRACT

Adhesive tape for the roll change of flat-web materials, having an extensively splittable carrier, at least one layer of adhesive disposed above the splittable carrier, and a layer of adhesive disposed below the splittable carrier, wherein at least between the splittable carrier and the layer of adhesive below the splittable carrier there is a first barrier layer which is impervious to calcium ions.

The invention relates to an adhesive tape for the roll change of flat-web material, more particularly paper, wound into rolls, and also to a method for a roll change of this kind.

The roll change of flat-web materials, such as of paper webs in the newspaper industry, is nowadays largely an automated process. First the end of the topmost web (the end of the topmost flat web from the “viewpoint” of the roll turn, corresponding to the start of the new flat web from the “viewpoint” of the operation) of a new roll of flat-web material is bonded so that this end cannot part from the roll. Frequently employed for this purpose are adhesive tapes which have two functions: firstly they serve for the above-described end bonding of the roll. Secondly their design is such that it is possible to expose an adhesive area which is able to effect the attachment of the topmost flat-web ply of the new roll to an old, expiring flat web. This attachment (adhesive attachment) is accomplished by accelerating the new roll to substantially the same speed at which the old flat web is running through the operation, and then guiding it onto the old flat web at this speed by the free adhesive area. Simultaneously with this attachment, the end bonding of the new flat web must be parted, so that the old flat web, with the start of the new paper web bonded to it, is drawn, so to speak, into the operation, and hence a quasi-continuous (“endless”) flat web passes through the operation, the printing machines of the newspaper industry, for example. The seam is removed in a later operating step, for example after the completed newspapers have been cut, and so these seams do not reach the customer.

Adhesive tapes suitable for bonding as described above are known in the art. Adhesive tapes are described, for instance, which have an extensively splittable carrier provided with an adhesive both on its top face and on its bottom face. The stated adhesive tapes are typically part of adhesive tapes which have a somewhat more comprehensive product construction than a three-layer system. Adhesive splicing tapes of this kind are described for example in the specifications DE 196 28 317 A, DE 198 30 674 A, DE 199 02 179 A, DE 199 58 223 A, DE 100 58 956, DE 101 23 981, WO 03/20623 A, WO 03/24850 A, DE 102 10 192 A, DE 102 58 667, DE 10 2004 028 312 A, DE 10 2005 051 181 A.

The extensively splittable carrier is selected such that, while securely holding the end of the topmost flat web on the roll during the acceleration of the new roll, it nevertheless securely and reliably opens this end bonding at the point of bonding to the old, expiring flat web under the peak in force that occurs there. Extensively splittable papers have emerged as being suitable for this purpose. Deriving from their production, however, such papers contain a series of fillers, especially inorganic fillers, particularly metal ions, which it is almost impossible to avoid in the production operation.

In contact with filler-containing papers, however, the (pressure-sensitive) adhesives used for the adhesive splicing tapes whose principal application is in products for the papermaking and downstream paper-processing industry frequently exhibit a sharp incursion into their adhesive properties, possibly going as far as the complete loss of bond strength and tack. This problem occurs in particular when the adhesive tapes are stored for a certain period.

Filler-containing substrates, especially papers, may give off polyvalent metal ions as a result of ageing processes or external influences. A problem arises in particular as a result of the calcium ions that are frequently present in the paper, or in substances with which the paper has been treated, since calcium is a filler used increasingly and commonplace in the paper industry and is a co-component in coating slips.

The loss of properties on the part of the (pressure-sensitive) adhesive can be attributed in particular to migration of the metal ions into the adhesive. In this way, the deliberately crosslinked carboxyl-containing and/or acid-containing copolymers may undergo uncontrolled after-crosslinking beyond the desired extent. This after-crosslinking results in a deleterious influencing of the rheological profile such that a massive increase in cohesion and, concomitantly, a reduction in tack is brought about, which at its worst goes as far as the complete loss of bond strength and tack.

A particular risk then exists that the bond strengths will no longer be sufficient to provide secure holding of the end bond when the new roll is being accelerated. If this bond breaks, however, the topmost flat web parts, and a breakdown of the continuous process is the result. Such interruptions entail considerable costs.

Particularly for application in the paper-processing industry, as for example in connection with flying roll change (flying splice), the profile of requirements imposed on the adhesive tapes to be employed is therefore strict. Accordingly these adhesive tapes must—over the entire duration of use—exhibit high tack, good cohesion and good repulpability [the ability to be incorporated into the pulp, in other words into the slurry of paper or fibre dissolved or suspended in water, during the reprocessing of (waste) paper; not automatically synonymous with “water solubility”].

It was an object of the invention, therefore, to offer improved adhesive tapes for flying splice that do not have the disadvantages of the prior art and that in particular exhibit a high storage stability without loss of or reduction in the bond strength of the pressure-sensitive adhesives.

This object is achieved by means of an adhesive tape as described hereinbelow.

Correspondingly the present invention relates in one embodiment to an adhesive tape for the roll change of flat-web materials, comprising an extensively splittable carrier, at least one layer of adhesive disposed above the splittable carrier, and a layer of adhesive disposed below the splittable carrier, wherein at least between the splittable carrier and the layer of adhesive below the splittable carrier there is a first barrier layer which is impervious to calcium ions (Ca²⁺).

The barrier layer is suitable in particular for preventing direct contact between the paper layer, in which there are the inorganic constituents, especially the calcium ions, and the adhesive. Migration of these ions and of other disruptive constituents of the paper into the adhesive is therefore prohibited.

The barrier layer ought in particular to be extensively impenetrable, in other words to have no imperviosities. A particularly preferred procedure is to apply the layer to the carrier, more particularly to the paper carrier. Advantageously the dispersion layer is dried after this, and so a dry or largely dry barrier layer is obtained. Following the application of the dispersion or, in particular, after it has been dried, the layer of adhesive can then be applied, and so at no time is there direct contact of the carrier with the adhesive.

The barrier layer must exhibit good contact both to the carrier layer and to the layer of adhesive, in order to prevent the system falling apart during the splicing operation (this could happen, especially in the case of inadequate strength during the shearing stresses that occur). It is therefore useful if the barrier layer, before the adhesive is applied, is corona-treated—that is, exposed to a high-voltage electrical discharge. A corona treatment enhances the anchorage of the adhesive on the barrier layer.

With particular preference, between the splittable carrier and the layer of adhesive above the splittable carrier, there is a second barrier layer which is impervious to calcium ions. This layer too is advantageously first applied to the carrier and preferably dried. Then the corresponding layer of adhesive can be applied. Here again, a corona pretreatment is advantageous. The second barrier layer advantageously also has the same composition as the first barrier layer.

In one particularly preferred development of the adhesive tape of the invention there is a further carrier—referred to below as “second carrier”—above the layer of adhesive provided above the splittable carrier, and on this second carrier there is in turn a layer of adhesive—referred to below as third layer of adhesive. The actual bond to the outgoing, expiring flat web is then produced by this (additional) part of the adhesive tape. A second carrier of this kind in particular accommodates the tensile forces which occur during the splicing operation. Accordingly the splittable carrier is freed, so to speak, from this function, allowing it to be optimized more effectively for the splitting operation. Fastening between the splittable carrier and the second carrier may be accomplished in particular by means of any desired adhesive (provided above the splittable carrier) which must only be sufficiently strong to guarantee sufficient strength of the adhesive bond at any time—thus including in the splicing operation. With particular advantage, use is made here of a self-adhesive composition; alternatively it may also, for example, be of curing type.

Important qualities of the second carrier are the physical properties, primarily the tensile strength. The latter is to be higher than the web tensions in the printing machine or other operating machines. Particularly in the case of machines having relatively low web tensions, the second carrier can also be selected to be relatively thin. This has advantages for the processing operation, since thinner materials disrupt travel through the machines to less of an extent.

The second carrier may also be composed of paper, which is advantageous for repulpable adhesive tapes in particular. In order to attain high tensile strengths, however, it is also possible advantageously to make use of films and foils (for example polymer films, metal foils).

It is particularly advantageous if the second carrier is wider than the splittable carrier. At the same time, the system composed of splittable carrier and two layers of adhesive (also referred to, for this embodiment of the invention, as an “understuck adhesive tape”) is preferably disposed not centrally but instead towards one edge of the second carrier. In a first embodiment, one of the long edges of the understuck adhesive tape and one of the long edges of the second carrier may be arranged flush. Preferably, however, the understuck adhesive tape is indented from one of the long edges of the second carrier, at a distance (V). For the use of the invention in flying splice it has emerged as being very advantageous if the understuck adhesive tape is indented at a distance (V) of up to 15 mm, particular 0.5 to 7 mm, more preferably at a distance of 1.5 to 4 mm, very preferably of 2 to 3.5 mm.

As experiments have revealed, it is advantageous, for a successful operating regime at high speeds, to introduce the force for the splitting process into the splittable carrier of the splitting strip, since otherwise there are local instances of uncontrolled tearing (referred to as “tears” above). For this purpose, the protruding section of the adhesive tape, defined by the distance of the splitting strip from the long edge, serves as a force introduction aid. It has been possible to avoid tears with particular success when this distance attains a certain magnitude.

If, however, the indentation is large (in particular more than 3.5 mm), there are increased instances of the protruding, front section of the adhesive splicing tape folding over, and there are likewise instances of uncontrolled behaviour during the splicing operation, as is also observed in experiments.

The width of the adhesive tape (given in particular by the width of the splittable carrier and by the width of the second carrier, where present) is advantageously between 30 and 120 mm, more preferably between 40 and 80 mm, very preferably 50 mm.

On the top face of the adhesive tape there may be a liner, comprising in particular a release material; this is suitable in particular for allowing the adhesive tape to be handled, and, in particular, of providing a release effect between the individual adhesive-tape plies when the adhesive tape is being wound. The liner is composed in particular of a siliconized material, preferably of siliconized paper.

The liner may be divided into two sections, or made ready for a possible division, by means of a cut or a predetermined breakage point, in the form in particular of a perforation, a partial cut, slitting or the like, which extends in the lengthwise direction of the adhesive tape.

The cut or predetermined breakage point in the liner material, when the latter is present, may be provided preferably at a distance of 20 to 40 mm from the left-hand bordering edge of the adhesive tape.

The barrier layer is produced advantageously using dispersions which comprise film-forming components. The film-forming components ought to be selected such that they do not penetrate into the open (porous) surface structure of the carrier to be coated, more particularly of the paper, and so do not substantially alter the mechanical properties of the carrier material (of the paper in particular). A substantial alteration to the paper's properties would be, in particular, if it were to lose its strength, needed for the carrier function, or were to suffer reduction in its splittability properties, as needed for the function during roll change.

Aqueous latex dispersions have emerged as being particularly suitable for forming the barrier layer. In this case, however, care should be taken to ensure that latex dispersions are used whose latex droplets do not penetrate the carrier material (particularly paper) of the splittable carrier, since otherwise there might be reinforcement of the material, and the reliability of the splitting process might no longer be ensured. Therefore non-polar latices are used with particular advantage.

For use in the paper-processing industry in particular it is advantageous if some, more preferably most, and even better all of the constituents of the adhesive tape of the invention that are employed in the operation are repulpable—that is, in particular, water-soluble or dispersible. The same ought preferably to apply to the film-forming components used to produce the barrier layer.

The latices may with advantage be latices based on acrylate (AC), based on carboxylated acrylates (carbox. AC), based on carboxylated styrene-butadiene rubbers (carbox. SBR), based on modified styrene-butadiene rubbers (mod. SBR), based on acrylate-styrene (AC-S), based on acrylate-acrylonitrile, based on butyl acrylate-styrene (BA-styrene) and/or based on butyl acrylate-styrene-acrylonitrile (BA-styrene-AN), to give but a few examples. A series of commercially available products have emerged as being very suitable in accordance with the invention, and are shown in the table below, without any intention that their indication should represent unnecessary restriction.

| Manufacturer | Name | Type |
|---|---|---|
| PolymerLatex | LP 2004/78 | acrylate |
| PolymerLatex | LP 2004/79 | carbox. SBR |
| DOW Reichhold | XZ 94457.05 | carbox. SBR |
| DOW Reichhold | XZ 94445.00 | carbox. SBR |
| DOW Reichhold | XZ 91988.00 | mod. SBR |
| SYNTHOPOL | DRR 1983 | highly carbox. AC |
| SYNTHOPOL | DRR 1984 | slightly carbox. AC |
| SYNTHOPOL | DRR 1985 | slightly carbox. AC |
| SYNTHOPOL | DRR 2006 | AC-S |
| Alberdingk-Boley | KDA 10 | AC-S |
| Alberdingk-Boley | V 50822 | AC |
| Alberdingk-Boley | V 50823 | AC |
| Alberdingk-Boley | AC 543 | AC |
| Alberdingk-Boley | AC 2522 | AC |
| Alberdingk-Boley | AC 25481 | AC |
| BASF | ACRONAL 500 D | AC |
| BASF | ACRONAL DS 2373 | acrylate-acrylonitrile |
| BASF | ACRONAL S 728 | BA-styrene |
| BASF | ACRONAL S 560 | BA-styrene-AN |
| Rohm & Haas | Primal P-376 LO | AC |
| Rohm & Haas | Robond PS-8534 | AC |

With the barrier layers of the invention a good balance has been struck between the thickness of the barrier layer and the barrier effect. Whereas, generally speaking, the barrier effect increases as the barrier layer thickness increases, it is advantageous for the use of the adhesive tape to minimize the overall thickness of the adhesive tape in order to allow the adhesive tapes to run through without problems in continuous operation (e.g. through calenders).

The barrier layers may advantageously have a thickness of up to 10 μm, corresponding in the case of aqueous dispersions to an application of up to 10 g/m². Barrier layer thicknesses of approximately 5μ (corresponding to 5 g/m²) have proved to be particularly outstanding. These thicknesses allow effective use for roll change, especially flying roll change or flying splice; with the compositions selected to produce the barrier layer it is possible thus to realize layers which have an outstanding barrier effect but nevertheless are thin.

In one outstanding embodiment of the adhesive tape of the invention the splittable carrier is a one-piece (single-ply) carrier which can be split extensively on exposure to appropriate forces. The adhesive bond provided by this adhesive tape can be parted again by virtue of the splittable carrier splitting extensively, more particularly splitting substantially centrally; the respective layers of adhesive are covered non-adhesively by the extensive residues of the split carrier that remain after splitting.

The splittable carrier may also be of multi-ply construction, with one of the carrier layers being splittable.

Carriers or carrier layers referred to in accordance with the context of this specification as being “splittable” are those which are splittable parallel to their superficial extent, and especially those carriers which, based on the requirements in a splicing process, do actually split. “Substantially central splitting” in the sense of this invention means that the splitting produces extensive residues of carrier, as split products, that are of approximately equal thickness, as set against a substantially non-central splitting, in which (extensive) carrier residues of significantly different thickness are produced as split products. In particular, substantially central splitting of the one-piece carrier or of the splittable carrier layer of a multi-ply carrier is to be characterized in that the split products reliably and non-adhesively cover the corresponding adhesives. In the case of asymmetrical splitting, this would possibly not be ensured on the part of the excessively thin extensive carrier residue.

The extensive splitting of a single-ply splittable carrier or of a splittable carrier layer will be, in particular, extensive tearing of the carrier or of the carrier layer, respectively.

Splittable carriers contemplated include all splittable extensive carrier materials, especially readily cleaving papers, kraft papers, composite paper systems (for example duplex papers and sized paper systems), film composite systems (sized film systems, for example), polymeric composite systems (coextruded polymeric composite systems, for example) and polymeric nonwovens.

Advantageously, and especially for an adhesive tape where there is a second carrier on the top face, a splittable carrier is used whose splitting strength is substantially lower than that of a carrier which is required to accommodate tensile forces. Particular preference is given to using a splittable carrier which has a substantially lower tear propagation resistance than a carrier or a carrier layer which accommodates the actual tensile forces in the main plane of the adhesive tape (i.e. than the second carrier), in order to join the two webs of material to one another. Accordingly the system carrier is split before the main carrier is destroyed. The splittable carrier or carriers are based preferably on paper. By way of example, the following papers or composite paper systems are especially suitable for this purpose:
sized, highly compacted papers
readily splittable paper systems, e.g. papers not possessing wet strength
kraft papers (for example, kraft papers glazed on both sides—a kraft paper found to be particularly suitable is one with a thickness of 55 μm and a basis weight of 65 g/m²)
duplex papers
   (papers with defined lamination, the splitting process is extremely homogenous; there are no stress peaks as a result, for example, of inhomogeneous compaction.
   These papers are used for producing wallpapers and filters.)
splittable systems in which the splitting forces are determined via the size of the bonding points; splittable systems of this kind are described for example in DE 198 41 609 A1.

The top adhesive and the bottom adhesive of the adhesive tape ought to have a high bond strength. In particular it is of advantage if the bond strengths of these self-adhesive compositions are greater on the respective surfaces (carrier and substrate) than the force needed for splitting of the splittable carrier. Advantageous splittable carriers preferably have splitting strengths of 15 to 70 cN/cm, more particular of 22 to 60 cN/cm, especially of 25 to 50 cN/cm. With regard to splitting strength and its measurement, refer to DE 199 02 179 A1.

In one variant of the adhesive tape of the invention the splittable carrier is not single-ply and extensively splittable, but instead takes the form of two layers which can be parted extensively from one another (delaminable layers). These may be, in particular, paper/paper laminates or else a laminate of paper with film. Examples of systems suitable for this purpose are in particular the following paper-based and/or film-based laminate or composite systems:
duplex papers
   (papers with defined lamination, the splitting process is extremely homogenous; there are no stress peaks as a result, for example, of inhomogeneous compaction.
   These papers are used for producing wallpapers and filters.)
splittable systems in which the splitting forces are determined via the size of the 20 bonding points; systems of this kind are described for example in DE 198 41 609 A1.

For repulpable adhesive tapes in particular a laminate of two papers is advantageous. Examples of paper laminates of this kind are
highly compacted papers sized together in a defined manner (in particular, papers having a high splitting strength). Sizing may be carried out, for example, using starch, starch derivatives, wallpaper pastes based on methylcellulose (tesa® Kleister, tesa AG, Hamburg; Methylan®, Henkel KGaA, Düsseldorf) or else based on polyvinyl alcohol derivatives. A description is given of such laminate systems in EP 0 757 657 A1, for example.

The laminate may also be a laminate of a polymer layer with paper, the polymer more particularly being a polymer which can be applied by printing technology, such as gravure printing, screen printing or the like, for instance. Particularly suitable for the polymer here are curing polymer compositions, but also solvent-borne compositions, from which the solvent is removed following application, forming the layer, and, furthermore, polymer compositions which soften in the heated state, in other words have sufficient viscosity to be applied at service temperature but take the form of a sufficiently stable layer.

The adhesive bond formed by means of such an adhesive tape can be parted again by extensive parting (delamination) of the two layers of the splittable laminate carrier from one another; the respective layers of adhesive are covered non-adhesively by the extensive layers of the carrier that remain after parting.

The core concept of a system of this kind is that the splitting operation of the splittable carrier occurs between two mutually separable layers and not within one layer. Accordingly, for example, no fibres are extracted from a paper carrier, and the force needed to part the layers can be precisely defined.

Furthermore, prolonged storage of the adhesive tape must not result in any substantial change in the forces needed to part the layers. In the case of a laminated carrier, therefore, the film-forming components employed advantageously ought likewise to be selected such that they do not penetrate the open (porous) surface structure of the carrier to be coated, especially the paper; in this case, penetration of such substances could lead to a change in the delamination behaviour and hence likewise alter the stability of the splittable carrier.

The two layers can be joined in any desired way or, preferably, as described below. Preference here as well is given to using a splittable laminate carrier which has a substantially lower “tear propagation resistance” (based on the delamination process) than a carrier or a carrier layer that accommodates the actual tensile forces in the main plane of the adhesive tape (i.e., than the second carrier) in order to join the two webs of material to one another. Hence the splittable carrier is able to delaminate before the second carrier or one of the laminate carrier layers is destroyed. In this case, then, the adhesive tape is composed of at least two layers which undergo delamination under a defined exposure to force which is exceeded in the course of the flying splice.

The parting strength of the laminate or of the two-carrier-layer systems has in particular the numerical values as indicated above for the splitting strength of the extensively splitting, one-piece carrier.

The advantage of an adhesive tape as described above is that the force needed to part the parting system remains continually constant, and so a flying splice can be performed under controlled conditions, and incorrect functioning of the adhesive tape is prevented.

The adhesives (adhesive below the splittable carrier, adhesive above the splittable carrier and/or third layer of adhesive) of the adhesive tape of the invention are, in particular, self-adhesive compositions. It is possible with outstanding effect—and selectably independently of one another in relation to the individual layers—to make use, among others, of acrylates (water-soluble and/or water-insoluble), natural rubber compositions, synthetic rubber compositions, mixtures of the aforementioned compositions, compositions based on copolymers and/or block copolymers, especially based on acrylates and/or natural rubbers and/or synthetic rubbers and/or styrene. In particular it is possible with advantage to use dispersions, hot-melt (including hot-melt-processable) adhesives and/or solvent-borne adhesives. The adhesives are selected with a view to the particular intended field of use of the adhesive tape of the invention (in particular, flying splice, static splice, roll end bonding, etc.).

For acrylate adhesives in particular, no calcium ions should be able to migrate from the carrier layer into the layer of adhesive.

In particular it is advantageous to use (self-)adhesive compositions of particularly high shear strength; moreover, the other variables that determine the adhesive properties, such as tack, cohesion, viscosity, degree of crosslinking, etc., ought to be optimized in accordance with the invention for the particular intended use, something which can be done by methods familiar to the skilled worker. It may be pointed out that in principle all basic types of pressure-sensitive adhesives that meet the inventive criteria can be employed.

Typical thicknesses for the layers of adhesive are between 25 μm and 100 μm. Typical basis weights of the layers of pressure-sensitive adhesive are situated in the range of 20 g/m² and 80 g/m².

In one advantageous embodiment of the adhesive tape of the invention the adhesive tape is additionally provided with a detectable layer and/or at least one of the layers already described is provided with a detectable feature. This allows the adhesive to be detected by means of suitable detecting apparatus during the (splicing) operation. In particular by this means it is possible to achieve automated control of the operation. Given a suitable choice of the detectable feature, it is also possible by this means to transfer additional information (beyond a yes/no information item).

Detection of the layer is accomplished preferably by optical and/or electromagnetic means. For example, one of the layers may be provided with an optically detectable pattern which can be ascertained using suitable sensors in the course of travel through the machine. In a similar way, one of the layers may contain an electromagnetically detectable feature, a metallization for example, which can be ascertained using an electromagnetic sensor. On the basis of the detectability of at least one of the layers, in the course for example of the acceleration of a paper roll provided with such an adhesive tape, the adhesive tape is detected and hence the splicing or joining operation to the end of the web of the old roll is initiated at the correct point in time. Furthermore, when the paper web is processed further in what is known as a reject diverter, the adhesive tape can be detected, in order to separate out this section with the spliced connection. Thus the adhesive tape takes on the function of hitherto additionally applied labels or markings which, in the prior art, were applied manually to a roll of a web material, which led frequently to malfunctions, since the label was applied at the wrong place. Hence it is ensured that, on the basis of the ability for the adhesive tape to be detected, the precise position of the bond can be determined automatically and this join can be cut off or separated out always automatically at the correct location. With this detectable adhesive tape it is also possible to obtain information concerning the process sequence on the basis of the rotational speed of the roll, since, for example, the movement of the adhesive tape allows information to be derived directly concerning the transport speed of the web. In a simple way the detectable layer is a metal foil, especially aluminium. The detectable layer, for example an aluminium foil, has a thickness for example of 6 to 12 μm. It is also possible for the detectable layer to be a paper sheet provided with metallization or with metallic fractions. If one of the layers is a metal foil, the other layer preferably takes the form of an acrylate dispersion, polymethyl methacrylate (PMMA), latex, polyvinyl acrylate (PVA), polyvinyl chloride (PVC) or copolymer of these substances. With these substance combinations it is possible for the above-stated tear propagation resistances to be set in a defined and desired manner. In this context, even on prolonged storage of the adhesive tape, there are no changes in these strength values, since the forces of adhesion between these materials remain unchanged. It will be understood that both the metal foil and the further layer are each provided with a self-adhesive composition on their outer sides. This self-adhesive composition is preferably a water-soluble or water-insoluble, self-adhesive acrylate composition. In the same way, it is possible to use natural rubber and synthetic rubber compositions and also dispersions of the compounds described above.

It may further be advantageous for the detectable layer to be applied in turn to a carrier. In that case the detectable layer is disposed on one side of the carrier and the associated self-adhesive composition on the other side of the carrier. The carrier may be composed of paper or a film/foil. The carrier may be, among others, a smooth, white, bleached kraft paper.

### BRIEF DESCRIPTION OF THE DRAWINGS

The adhesive tape of the invention is to be elucidated in greater detail with reference to FIGS. 1 to 4, without any intention that the examples shown should restrict the concept of the invention unnecessarily. In the figures:

FIG. 1 shows an inventive adhesive tape with a splittable carrier and a barrier layer

FIG. 2 shows an inventive adhesive tape with a splittable carrier, a barrier layer and a second carrier

FIG. 3 shows an inventive adhesive tape with a splittable carrier and two barrier layers

FIG. 4 shows an inventive adhesive tape with a splittable carrier, two barrier layers and a second carrier

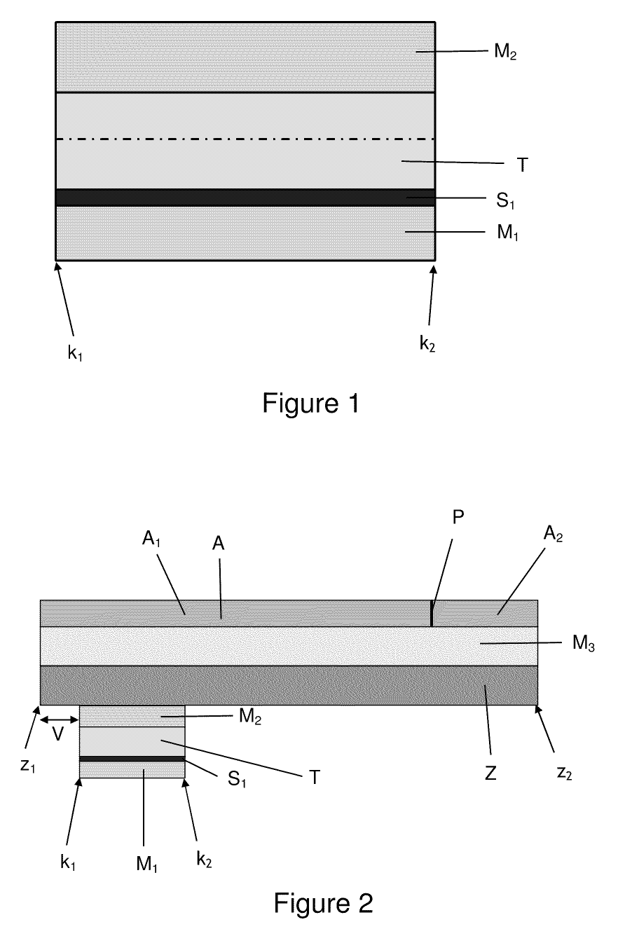

FIG. 1 shows an inventive adhesive tape with a splittable carrier (T). On the top face of the splittable carrier there is a layer (M₂) of adhesive; a further layer (M₁) of adhesive is located beneath the splittable carrier (T). Between the lower layer (M₁) of adhesive and the carrier layer there is a barrier layer (S₁) which is impervious to calcium ions.

FIG. 2 shows an inventive adhesive tape for which an adhesive tape as per FIG. 1 is understuck to a second carrier (Z). The splittable carrier (T) is fastened to the second carrier (Z) by means of the adhesive (M₂). Disposed on the top face of the second carrier (Z) is a third layer (M₃) of adhesive which makes the bonded connection to the outgoing flat web in the course of the roll change. FIG. 2 shows that the top, third adhesive (M₃) can be provided with a liner (A) which advantageously has a perforation (P), a cut or the like and so is divided into two partial liners (A₁, A₂).

The width of the understuck adhesive tape [extent between the long edges (k₁, k₂)] is smaller than the width of the second carrier (Z) [extent between its long edges (z₁, z₂)]. The understuck adhesive tape is not disposed centrally (based on the width) under the second carrier, but is instead disposed with a shift toward one long edge (z₁) of the second carrier (Z). The understuck adhesive tape is arranged indented by a distance (V) from this long edge (z₁) of the second carrier (Z).

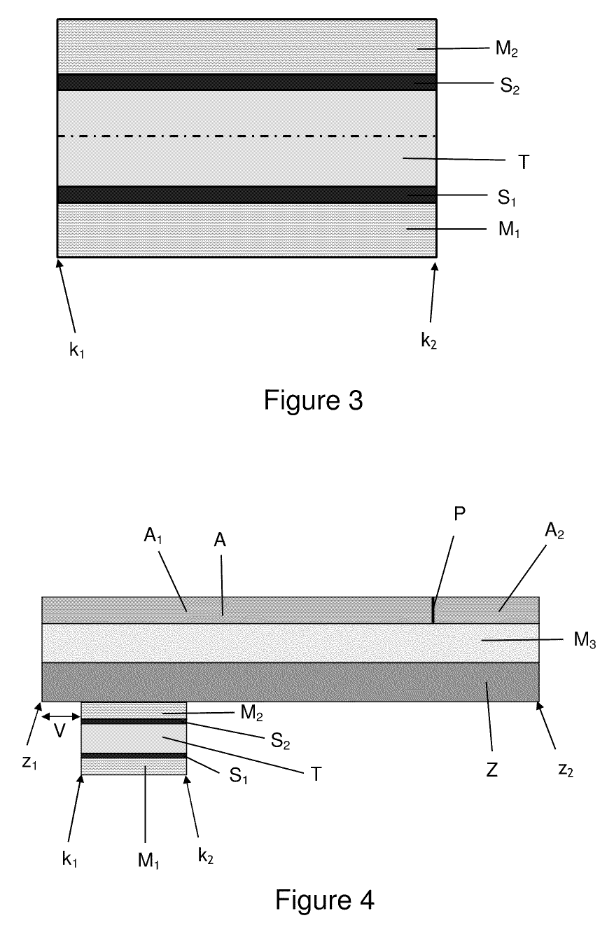

FIG. 3 shows an adhesive tape corresponding to the version in FIG. 1, but where a further barrier layer (S₂) is provided between the splittable carrier (T) and the adhesive (M₂) above this carrier (T).

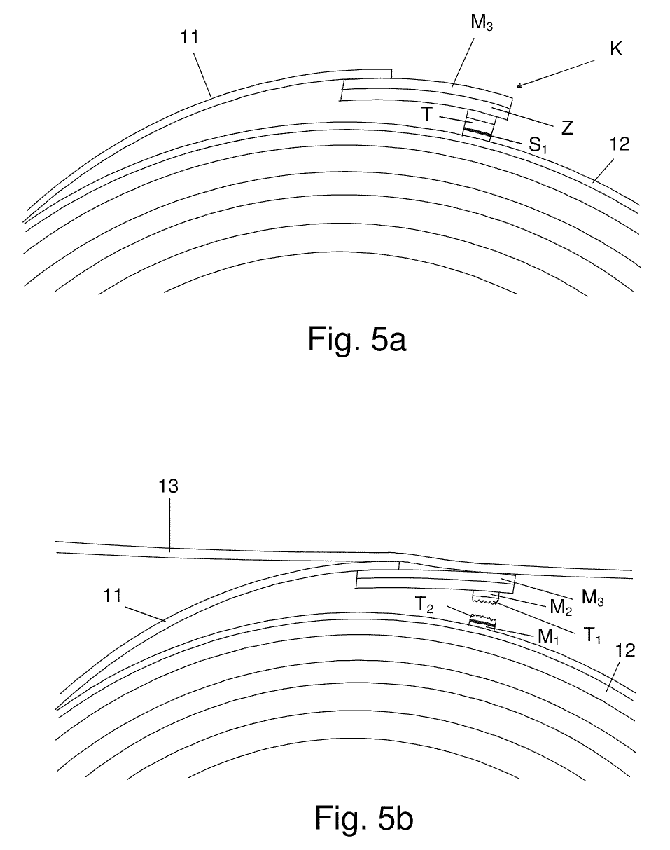

FIG. 4 shows an adhesive tape corresponding to FIG. 2 with an understuck adhesive tape corresponding to FIG. 3.

Splice Method

The invention further provides a method for flying roll change (flying splice) using an adhesive system of the invention or an adhesive tape of the invention.

In the case of a first variant (not shown graphically), using an adhesive tape corresponding to one of FIGS. 1 and 3, of the method of the invention, the topmost flat-web turn (11) (in particular its end or its end region) of a new roll is fixed by means of an adhesive system (S), which is suitable for obtaining an adhesive bond which can be parted again free from adhesive areas, on the underlying flat-web turn (12), so that the part of a self-adhesive composition (M₂) needed for joining to the outgoing flat web (13) is exposed. Thereafter the new roll thus equipped is placed adjacent to an almost entirely unwound, old roll that requires replacement, and is accelerated to substantially the same rotary speed as that roll, and then is pressed against the old flat web (13), the exposed self-adhesive composition (M₂) of the adhesive tape (K) bonding to the old flat web (13) when the webs have substantially the same speeds, while at the same time the bond of the topmost flat-web ply (end ply of the turn) (11) to the underlying flat-web ply (12) splits in such a way that, after the parting operation, there are no adhesive regions exposed, the tape used being an inventive adhesive tape (K).

In the case of a further variant of the method of the invention, as shown diagrammatically in FIGS. 5a and 5b, with an adhesive tape corresponding to one of FIGS. 2 and 4, without thus wishing to impose any unnecessary restriction on the concept of the invention, the topmost flat-web turn (11) (in particular its end or its end region) of a new roll is fastened using an adhesive tape (K), comprising at least one adhesive tape component that features a splittable carrier (T) and is suitable for obtaining an adhesive bond which can be parted again free from adhesive areas, to the underlying flat-web turn (12), so that the part of a self-adhesive composition (M₃) that is needed for joining with the outgoing flat web (13) is exposed (cf. FIG. 5a). Thereafter the new roll thus equipped is placed adjacent to an almost entirely unwound, old roll that requires replacement, and is accelerated to substantially the same rotary speed as that roll, then pressed against the old flat web (13), the exposed self-adhesive composition (M) of the adhesive tape (K) bonding to the old flat web (13) when the webs are at substantially the same speeds, while at the same time the bond produced by means of the adhesive tape (K) between the topmost flat-web ply (end ply of the turn) (11) and the underlying flat-web ply (12) is parted, by extensive splitting of the carrier (T), in such a way that, after splitting has occurred, there are no adhesive regions exposed, the tape used being an inventive adhesive tape (cf. FIG. 8b).

In a development of the inventive method, the adhesive tape is bonded at right angles to the running flat web. In other advantageous variants of the method of the invention, the adhesive tape can also be bonded at an acute angle of up to 30° with respect to the running flat web, more particularly of up to 10°. In the case of the splicing method, the adhesive tape (K) of the invention is bonded in a straight line beneath the end of the topmost flat-web ply (11) of a new flat-web roll (or at a small distance from the end of the topmost flat-web turn) to the new flat-web roll, leaving part of the adhesive tape (K) free, while the adhesive (M₁) below the splittable carrier (T) bonds to the underlying flat-web ply (12) and thus secures the topmost web ply (in particular the end of the topmost web ply); if desired, initially only part (A₂) of the liner (A), present if desired on the self-adhesive composition (M), has been removed, and so the part of the self-adhesive composition that is required for the splicing method is still lined with the liner (A₁) and the roll in this state does not have a free adhesive area. Thereafter, for final preparation for the splicing method, any remaining liner (A₁) is removed, after which the new roll thus equipped is placed adjacent to an almost entirely unwound, old roll that is to be replaced, and is accelerated to the same rotary speed as that roll. The new roll is then pressed against the old web (13), and the exposed self-adhesive composition (M) of the adhesive tape (K) bonds to the old web (13) when the webs are at substantially the same speeds, while at the same time the splittable carrier (T) splits, with both areas in the region of what had previously been the bond of the topmost flat-web ply (11) to the underlying flat-web turn (12) remaining non-adhesive.

The flat webs are, in particular, paper webs and/or film webs and/or webs of textile material (wovens, knits, nonwovens or the like).

1. Adhesive tape for the roll change of flat-web materials, comprising an extensively splittable carrier, at least one layer of adhesive disposed above the splittable carrier, and a layer of adhesive disposed below the splittable carrier,
wherein
at least between the splittable carrier and the layer of adhesive below the splittable carrier there is a first barrier layer which is impervious to calcium ions.

2. Adhesive tape according to claim 1, wherein the splittable carrier is composed of paper.

3. Adhesive tape according to claim 1, wherein between the splittable carrier and the layer of adhesive above the splittable carrier there is a second barrier layer which is impervious to calcium ions.

4. Adhesive tape according to claim 1, wherein at least one of the barrier layers below and/or above the splittable carrier is a barrier layer obtainable by applying a dispersion and subsequently drying if desired.

5. Adhesive tape according to claim 4, wherein the dispersion is a latex dispersion.

6. Adhesive tape according to claim 1, wherein above the layer of adhesive above the splittable carrier there is a second carrier above which in turn there is a third layer of adhesive.

7. Adhesive tape according to claim 6, wherein the second carrier has a greater width than the splittable carrier.

8. Adhesive tape according to claim 7, wherein between one long edge of the second carrier and the long edge of the splittable carrier located on that side there is a distance (V) of up to 15 mm.

9. A method of splicing a new roll of flat material to an unwinding old roll of flat material, said method comprising:
(a) adhering an adhesive tape according to claim 1 to a topmost web of said new roll;
(b) accelerating said new roll to substantially the same speed as said unwinding old roll; and
(c) pressing said new roll against said unwinding old roll to effect a splice between said new roll and said unwinding old roll.
